(19) United States
(12) Patent Application Publication
(10) Pub. No.: US 2006/0179295 A1
(43) Pub. Date: Aug. 10, 2006

(54) Multiple system image options selective booting method and interface

(75) Inventors: Ying-Chih Lu, Taipei (TW); Meng-Hua Cheng, Taipei (TW); Chun-Yi Lee, Taipei (TW); Chun-Lung Wu, Taipei (TW); Chi-Tsung Chang, Taipei (TW); Chia-Hsing Lee, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/054,983

(22) Filed: Feb. 9, 2005

(51) Int. Cl. G06F 9/24

(52) U.S. Cl. 713/2

(57) ABSTRACT

A multiple system image options selective booting method and interface is proposed, which is designed for use in conjunction with a computer platform for the user to select a desired system image from multiple available options contained in a system image source (such as a CD-ROM module) for booting up the computer platform with the user-selected system image. This feature allows the user to more conveniently select a desired system image from a collection of system image options for booting up a computer platform.

### BACKGROUND OF THE INVENTION

1. Field of the Invention

This invention relates to information technology (IT), and more particularly, to a multiple system image options selective booting method and interface which is designed for use in conjunction with a computer platform, such as a network server, for the implementation of a user interface that allows the user to select a desired system image from multiple available options stored in a system image source, such as a CD-ROM or the like, for booting up the computer platform with the selected system image.

2. Description of Related Art

A system image is-a clustered collection of all the operating system and application programs as well as related settings on a computer platform, and which is collected and prestored to a storage media, such as CD-ROM, hard disk, floppy disk, flash memory, and the like, such that the user can load operating system and application programs together with related settings into a computer platform, without having to load the operating system and application programs separately one by one. As the system image is loaded into a computer platform, it allows the computer platform to immediately booted up and ready for use to run the application programs.

Phoenix BIOS (Basic Input/Output System) is a system program that is widely utilized on network servers. In practical implementation, the Phoenix BIOS is based on the standard El Torito Bootable CD-ROM Format Specification for loading a system image from a CD-ROM module onto a network server. One drawback to the use of Phoenix BIOS, however, is that it supports only one bootable CD-ROM image. For this sake, if a CD-ROM contains two or more system images, such as 4 system images: [1.2 M Diskette], [1.44 M Diskette], [2.88 M Diskette], and [Hard Disk], then it is impossible for the user to select a desired system image from these 4 options for booting up a computer platform.

### SUMMARY OF THE INVENTION

It is therefore an objective of this invention to provide a multiple system image options selective booting method and interface which allows the user to select a desired system image from two or more options contained in a CD-ROM or the like for booting up a computer platform with the user-selected system image.

The multiple system image options selective booting method and interface according to the invention is designed for use in conjunction with a computer platform, such as a network server, for the user to select a desired system image from multiple available options stored in a system image source, such as a CD-ROM or the like, for booting up the computer platform with the selected system image. This feature allows the user to more conveniently select a desired system image from a collection of system image options for booting up a computer platform.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the multiple system image options selective booting interface according to the invention; and

FIG. 2 is a schematic diagram showing an example of a screen display of a system image selection dialog box displayed by the multiple system image options selective booting interface of the invention on computer screen.

### DETAILED DESCRIPTION OF PREFERRED EMBODIMENTS

The multiple system image options selective booting method and interface according to the invention is disclosed in full details by way of preferred embodiments in the following with reference to the accompanying drawings.

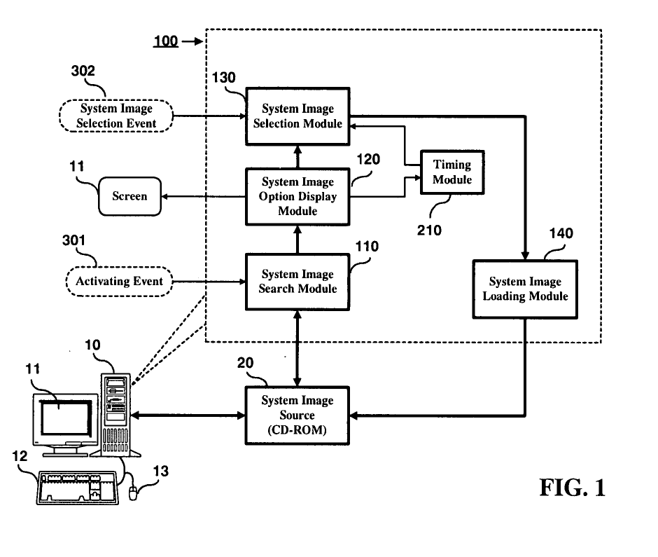

FIG. 1 is a schematic diagram showing the application architecture and modularized object-oriented component model of the multiple system image options selective booting interface according to the invention (as the part enclosed in the dotted box indicated by the reference numeral 100). As shown, in practical application, the multiple system image options selective booting interface of the invention 100 is designed for use as an add-on software/firmware module for integration to a system program, such as the BIOS (Basic Input/Output System) program on a computer platform 10 (such as a network server), for the user to select a desired system image from multiple available options stored in a system image source 20, such as a CD-ROM or the like, for the purpose of booting up the computer platform 10 as well as load application programs into the computer platform 10 with the user-selected system image.

In a practical application, for example, it is assumed that the system image source 20 is a CD-ROM module which contains the following system images: (1) 1.2 M Diskette; (2) 1.44 M Diskette; (3) 2.88 M Diskette; and (4) Hard Disk (where M denotes “megabyte”).

As shown in FIG. 1, the modularized object-oriented component model of the multiple system image options selective booting interface of the invention 100 comprises: (a) a system image search module 110; (b) a system image option display module 120; (c) a system image selection module 130; and (d) a system image loading module 140; and can further optionally comprise a timer module 210.

The system image search module 110 is capable of responding to an activating event 301 (such as the pressing of a power button or reset button on the computer platform 10 by the user) by searching through the system image source 20 (which is for example a CD-ROM module) for all available system images contained in the system image source 20. In practical implementation, for example, the system image search module 110 is based on the standard El Torito Bootable CD-ROM Format Specification for providing this system image search function. Since the El Torito specification is a well-known standard in the information industry, detailed description thereof will not be given in this specification

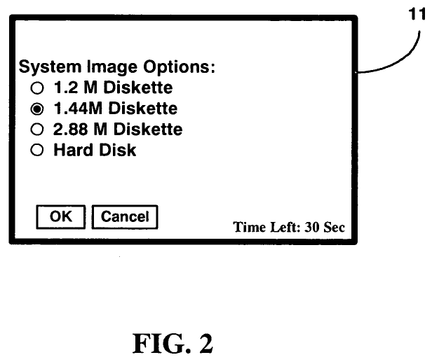

The system image option display module 120 is capable of displaying all the system image options that are found out by the system image search module 110 from the system image source 20 in a user-perceivable message form (for example text-based message form) on the screen 11 of the computer platform 10. If the system image source 20 contains 4 system images: (1) 1.2 M Diskette; (2) 1.44 M Diskette; (3) 2.88 M Diskette; and (4) Hard Disk, then the system image option display module 120 will display the respective names of these 4 system image options on the screen 11 in a dialog box as illustrated in FIG. 2.

The system image selection module 130 is capable of providing a user-operated system image selection function that allows the user to utilize a control device, such as keyboard 12 or mouse 13, to select a desired system image from all the system image options displayed by the system image option display module 120 on the screen 11. As the user has selected a system image option by using the keyboard 12 or the mouse 13, it initiates the occurrence of a system image selection event 302, causing the system image selection module 130 to respond by generating a corresponding system image selection message to the system image loading module 140. In addition, the system image selection module 130 can further optionally include a user-settable function for the user to preset a priority level for each of the available system images in the system image source 20. For example, the user can assign the [1.2 M Diskette] system image to the first-level priority; the [1.44 M Diskette] system image to the second-level priority; the [2.88 M Diskette] to the third-level priority; and the [Hard Disk] system image to the fourth-level priority. It is to be noted that the priority can be arbitrarily assigned by the user. If the system image selection module 130 has not received any user-initiated system image selection event 302, then it will automatically select the system image of the first-level priority that is best suited to the particular model of the computer platform 10.

The system image loading module 140 is capable of being activated after the system image selection module 130 has selected a system image to load the user-selected system image into the computer platform 10 for booting up the computer platform 10.

The timer module 210 is an optional module, which is preset to activate the system image selection module 130 to automatically select a suitable system image such as the one with the first-level priority (for example, the [Hard Disk] system image) at the termination of a preset time interval (such as 20 seconds) after the system image option display module 120 has displayed the available system image options on the screen 11 of the computer platform 10 but no user-initiated system image selection event 302 is received. In practical implementation, the timer module 210 can further optionally include a user-settable function for the user to set any desired value for the time interval; and if no user-specified value is received, the time interval is automatically set to a default value, such as 20 seconds. In addition, the timer module 210 can further optionally include the capability of displaying the elapsed time of the preset time interval in a countdown manner on the screen 11 of the computer platform 10, as for example illustrated in FIG. 2, for reminding the user to make a selection before timeout.

Referring to FIG. 1 together with FIG. 2, in the following example of an actual application, it is assumed that the system image source 20 is a CD-ROM module, and the CD-ROM module contains a total of 4 system images: (1) 1.2 M Diskette; (2) 1.44 M Diskette; (3) 2.88 M Diskette; and (4) Hard Disk. It is also assumed that the user wants to select the [1.44 M Diskette] system image for booting up the computer platform 10. In this case, the user needs first to initiate an activating event 301, such as by manually pressing a power button or reset button (not shown) on the computer platform 10. The activating event 301 will cause the system image search module 110 to respond by searching through the system image source 20 for all available system images contained in the system image source 20. If any system image is found (in this example, 4 system images are found), the system image option display module 120 is activated to display all the found system images, i.e., [1.2 M Diskette], [1.44 M Diskette], [2.88 M Diskette], and [Hard Disk], in a user-perceivable message form, such as a text-based message form, through a system image selection dialog box on the screen 11 as shown in FIG. 2. When the 4 available system image options are displayed on the screen 11, the user can then utilize a control device such as keyboard 12 or mouse 13 to select a desired system image option therefrom, and as the user has made a selection, it initiates the occurrence of a system image selection event 302, causing the system image selection module 130 to respond by generating a corresponding system image selection message to the system image loading module 140, thus activating the system image loading module 140 to respond by loading the user-selected system image into the computer platform 10 to thereby boot up the computer platform 10.

If the user hasn't made a selection after the system image option display module 120 has displayed the 4 available system image options on the screen 11 (i.e., no user-initiated system image selection event 302 is received) for a preset time interval, such as 20 second, then the timer module 210 will activate the system image selection module 130 to automatically select a suitable system image such as the one with the first-level priority (for example, the [Hard Disk] system image) at the termination of the preset time interval and load the [Hard Disk] system image from the system image source 20 into the computer platform 10 to boot up the computer platform 10.

In conclusion, the invention provides a multiple system image options selective booting method and interface for use with a computer platform for the user to select a desired system image from multiple available options contained in a system image source for booting up the computer platform with the user-selected system image. This feature allows the user to more conveniently select a desired system image from a collection of system image options for booting up a computer platform. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multiple system image options selective booting method for use on a computer platform to provide a user-operated multiple system image options selective booting procedure to boot up the computer platform with a selected system image from a collection of system images stored in a system image source;
the multiple system image options selective booting method comprising:
searching through the system image source for all available system images contained in the system image source;
displaying all the available options of system images in a user-perceivable message form on the computer platform for user-selection;
responding to a system image selection event to select one system image from the available system image options; and
loading the selected system image from the system image source onto the computer platform to thereby boot up the computer platform.

2. The multiple system image options selective booting method of claim 1, wherein the computer platform is a network server.

3. The multiple system image options selective booting method of claim 1, wherein the system image source is a CD-ROM module.

4. The multiple system image options selective booting method of claim 1, further comprising:
a priority setting procedure for setting a priority level for each of the available system images in the system image source.

5. The multiple system image options selective booting method of claim 1, further comprising:
performing a time countdown procedure for a preset time interval after the available system image options are displayed on the computer platform for user selection; and
at the termination of the preset time interval, if no user-initiated system image selection event is received, automatically select a prespecified system image from the available system image options.

6. The multiple system image options selective booting method of claim 1, further comprising:
displaying the currently elapsed time of the preset time interval in a countdown manner on a screen connected to the computer platform.

7. A multiple system image options selective booting interface for use with a computer platform to provide a user-operated multiple system image options selective booting procedure to boot up the computer platform with a selected system image from a collection of system images contained in a system image source;
the multiple system image options selective booting interface comprising:
a system image search module, which is capable of searching through the system image source for all available system images contained in the system image source;
a system image option display module, which is capable of displaying all the available options of system images found by the system image search module from the system image source in a user-perceivable message form on the computer platform;
a system image selection module, which is capable of providing a user-operated system image selection function for user-selection of a desired system image from all the system image options displayed by the system image option display module; and
a system image loading module, which is capable of being activated after the system image selection module has selected a system image to load the selected system image from the system image source onto the computer platform to thereby boot up the computer platform.

8. The multiple system image options selective booting interface of claim 7, wherein the computer platform is a network server.

9. The multiple system image options selective booting interface of claim 7, wherein the system image source is a CD-ROM module.

10. The multiple system image options selective booting interface of claim 7, wherein the system image option display module includes a user-settable function for setting a priority level for each of the available system images in the system image source.

11. The multiple system image options selective booting interface of claim 7, further comprising:
a timer module, which is preset to activate the system image selection module to automatically select a prespecified system image at the termination of a preset time interval after the system image option display module has displayed the available system image options on the computer platform but no user-initiated system image selection event is received.

12. The multiple system image options selective booting interface of claim 11, wherein the timer module is further capable of displaying the currently elapsed time of the preset time interval in a countdown manner on a screen connected to the computer platform.

13. The multiple system image options selective booting interface of claim 11, wherein the timer module further includes a user-settable function for setting a user-desired value for the time interval; and if no user-specified value is received, the time interval is automatically set to a default value.
